(19) United States
(12) Patent Application Publication
(10) Pub. No.: US 2007/0040985 A1
(43) Pub. Date: Feb. 22, 2007

(54) LIQUID CRYSTAL DISPLAY DEVICE AND METHOD OF MANUFACTURING THE SAME

(75) Inventors: Yasushi KAWATA, Saitama-ken (JP); Akio MURAYAMA, Saitama-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/419,861

(22) Filed: May 23, 2006

(30) Foreign Application Priority Data
Aug. 19, 2005 (JP) P2005-239043

(51) Int. Cl. G02F 1/13

(52) U.S. Cl. 349/187

(57) ABSTRACT

A polishing speed of large glass plate 51 subjected to a thermal treatment is slower than that of a large glass plate not subjected to such a thermal treatment when a chemical polishing process is applied to make those large glass plates thin. Large glass plate 51 prepared with a thermal history of a temperature of 400° C. is assembled with large glass plate 53 prepared with a thermal history of a temperature of not higher than 220° C. Large glass plates 51 and 53 are then immersed in chemical polishing solution and taken out therefrom simultaneously. Large glass plate 51 is made thinner in thickness than large glass plate 53. This causes great improvement in production yield of an LCD device.

### CROSS-REFERENCE OF RELATED APPLICATIONS

This application is based upon and claims the benefit of priority from the prior Japanese Patent Application No. 2005-239043, filed on Aug. 19, 2005, the entire contents of which are incorporated herein by reference.

### FIELD OF THE INVENTION

This invention generally relates to a liquid crystal display device in which first and second substrates hold a liquid crystal layer and a method of manufacturing the same.

### BACKGROUND OF THE INVENTION

Liquid crystal display (LCD) devices have the advantages of light weight, thin thickness, low power consumption and the like, and have been used for many applications, such as office automation equipment, clocks, television receivers, etc. LCD devices provided with thin-film-transistor (TFT) devices as switching elements are particularly so good for response that such LCD devices have been applied to image display units for portable television receivers, display monitors for personal computers and the like.

An LCD device includes a pixel array substrate made of a rectangular glass plate on which a plurality of pixels are formed. Each pixel is provided with a TFT device. The LCD device further includes a counter substrate made of another glass plate on which a color filter layer and a counter electrode are stacked in order. The counter substrate and the pixel array substrate are provided opposite to each other. A liquid crystal material is injected into a gap defined between the pixel array substrate and the counter substrate to make a liquid crystal layer as an optical modulator. The pixel array substrate and the counter substrate are assembled and are then sealed at their circumference by a sealant.

Recently, much thinner and lighter LCD devices have been required than before from viewpoints of appearance, design and portability in addition to functionality. In this connection, it is quite difficult to handle thinner and fragile glass plates used for the pixel array substrate and the counter substrate in a manufacturing process, resulting in the production yield reducing remarkably.

In order to overcome such difficulty, it is known that differently thick glass plates are used for the pixel array substrate and the counter substrate integrated with the pixel array substrate and that outer surfaces of the glass plates are subjected to a polishing process to make the glass plates thinner after such integration, as described in Japanese Patent Publication 7-49492, for example.

The usage of differently thick glass plates still causes restriction in a carrying system of an LCD device manufacturing process and warps due to different thermal-expansion coefficients of the glass plates at the time when the glass plates are thermally glued. In other words, the usage of differently thick glass plates does not easily improve the production yield rate.

### SUMMARY OF THE INVENTION

It is an object of the present invention to provide LCD devices and a method of manufacturing the same which can easily improve the production yield.

An aspect of the present invention is directed to a method of manufacturing an LCD device in which a first substrate with a first thickness is made at a first temperature while a second substrate with a second thickness substantially equal to the first thickness is made at a second temperature different from the first temperature. An inner surface of the first substrate is then provided opposite to that of the second substrate and the first and second substrates are put together. A chemical treatment on outer surfaces of the first and second substrates is applied to make the first and second substrates thin in thickness. A liquid crystal material is injected into a gap defined between the first and second substrates, circumferences of which, in turn, are sealed.

Since the first and second substrates are made at the different temperatures as set forth above, the chemical treatment makes the first and second substrates different in thickness when the chemical treatment is applied to them at the same time after the first and second substrates are put together. Thus, the first and second substrates can be carried easily in comparison with different thickness substrates. In addition, since thermal-expansion coefficients of the first and second substrates do not cause a warp when they are put together, the production yield rate of such a method of manufacturing an LCD device is significantly improved.

According to the present invention, the first and second substrates prepared are the same in thickness but are manufactured at different temperatures. The first and second substrates are then subjected to a chemical treatment at the same time. As a result, the first and second substrate are made thin differently. Thus, transportation of the first and second substrates in a production line can be easily carried out. Further, when the first and second substrates are assembled together, their different thermal-expansion coefficients do not cause a warp, so that the production yield rate can be improved significantly.

### BRIEF DESCRIPTION OF THE DRAWINGS

A more complete appreciation of the present invention and many of its attendant advantages will be readily obtained as the same becomes better understood by reference to the following detailed descriptions when considered in connection with the accompanying drawings, wherein:

FIG. 1 is a side view of a large LCD panel manufactured in accordance with a first embodiment of the present invention;

FIG. 2 is a plan view of the large LCD panel shown in FIG. 1;

FIG. 3 is a cross-sectional view of an LCD panel shown in FIG. 1;

FIG. 4 is a plan view of a line of strip-like LCD panels shown in FIGS. 1 and 2;

FIG. 5 is a plan view of the LCD panel shown in FIG. 4;

FIG. 6 is a side view of the LCD panel shown in FIG. 5;

FIG. 7 is a side view of a large LCD panel manufactured in accordance with a second embodiment of the present invention;

FIG. 8 is a plan view of the large LCD panel shown in FIG. 7;

FIG. 9 is a plan view of a single LCD panel separated from the large LCD panel shown in FIGS. 7 and 8;

FIG. 10 is a side view of the LCD panel shown in FIG. 9.

FIG. 11 is a side view of a large LCD panel manufactured in accordance with a third embodiment of the present invention;

FIG. 12 is a plan view of the large LCD panel shown in FIG. 11;

FIG. 13 is a plan view of a single LCD panel separated from the large LCD panel shown in FIGS. 11 and 12; and

FIG. 14 is a schematic side view of the LCD panel shown in FIG. 13.

### DETAILED DESCRIPTION OF THE INVENTION

Embodiments of the present invention will be explained below with reference to the attached drawings. It should be noted that the present invention is not limited to the embodiments but covers their equivalents. Throughout the attached drawings, similar or same reference numerals show similar, equivalent or same components. The drawings, however, are shown schematically for the purpose of explanation so that their components are not necessarily the same in shape or dimension as actual ones. In other words, concrete shapes or dimensions of the components should be considered as described in these specifications, not in view of the ones shown in the drawings. Further, some components shown in the drawings may be different in dimension or ratio from each other.

### First Embodiment

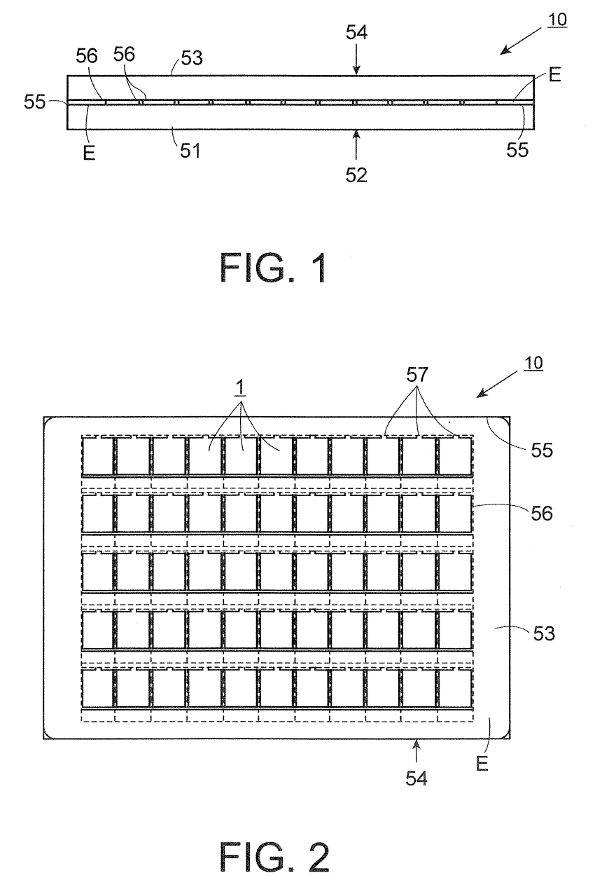

A first embodiment in accordance with the present invention will be described with reference to FIGS. 1-6 below.

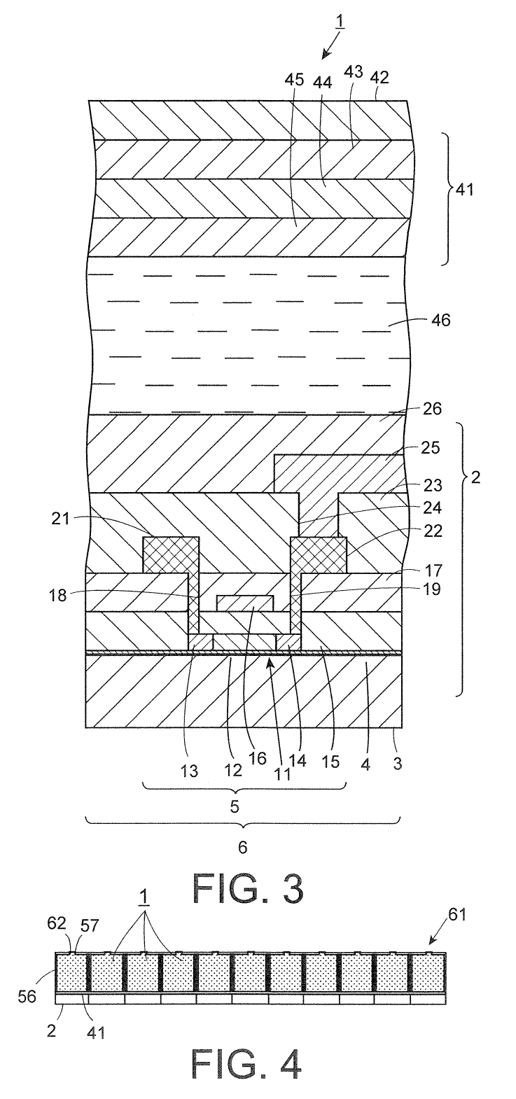

LCD panel 1 is shown in FIGS. 3, 5 and 6 as a flat device display device. LCD panel 1 is an active matrix type LCD device in which liquid crystal molecules are controllable for an optical modulation. LCD panel 1 is provided with a rectangular plate-like pixel array substrate 2 which is made by a thermal process at a maximum temperature of approximately 400° C., i.e., an approximately 400° C. thermal history. As shown in FIG. 3, pixel array substrate 2 has glass plate 3 which is an optically transparent and electrically insulated rectangular substrate. Glass plate 3 is 0.2 mm thick and a plurality of pixels 6 are formed on glass plate 3.

Undercoat layer 4 made from a silicon nitride film or a silicon oxide film is formed on a surface of glass plate 3. Thin-film transistor (TFT) devices 5 are provided in a matrix form on undercoat layer 4. TFT devices 5 are switching elements provided for pixels 6.

More concretely, TFT device 5 has active semiconductor layer 11 which is made from a poly-crystalline silicon semiconductor formed on undercoat layer 4. Active semiconductor layer 11 is a patterned island-like poly-crystalline thin film made by annealing an amorphous silicon semiconductor film and by patterning such an annealed amorphous silicon semiconductor film.

Active semiconductor layer 11 has channel region 12 provided at a central portion extending along a longitudinal direction of active semiconductor layer 11. The two end portions of channel region 12 are provided with source region 13 and drain region 14, respectively. Source region 13 and drain region 14 are electrically coupled to each of the two respective end portions of channel region 12 to form active semiconductor layer 11 together with channel region 12.

Channel region 12, source region 13 and drain region 14 are covered with gate insulation film 15 made from a silicon oxide film. Gate insulation film 15 is formed on active semiconductor layer 11 and undercoat layer 4. Gate electrode 16 is provided corresponding to channel region 12 and is isolated from channel region 12 by gate insulation film 15.

Gate electrode 16 and gate insulation film 15 are covered with interlayer insulation film 17. A plurality of contact holes 18 and 19 are made as openings of electrically conductive portions going through gate insulation film 15 and interlayer insulation film 17. Contact holes 18 and 19 are provided at source region 13 and drain region 14 on both sides of gate electrode 16 of TFT device 5, respectively. Contact holes 18 and 19 are connected to source region 13 and drain region 14, respectively.

An electrically conductive film is formed as source electrode 21 on interlayer insulation film 17 and is filled in contact hole 18 to connect with source region 13. Source electrode 21 is electrically connected to source region 13. An electrically conductive film is also formed as drain electrode 22 on interlayer insulation film 17 and is filled in contact hole 19 to connect with drain region 14. Drain electrode 22 is electrically connected to drain region 14.

Source electrode 21 and drain electrode 22 are apart and are electrically isolated from gate electrode 16. Source electrode 21, drain electrode 22, active semiconductor layer 11, gate insulation film 15, gate electrode 16 and interlayer insulation film 17 constitute TFT device 5. Thus, TFT devices 5 are formed as matrix type semiconductor patterns on glass plate 3.

Further, planarization film 23 is formed as a passivation film on source electrode 21 and drain electrode 22 of TFT device 5 and interlayer insulation film 17. Contact hole 24 is made in planarization film 23 as an electrically conductive portion going through planarization film 23. Contact hole 24 is electrically connected to drain electrode 22 of TFT device 5. Contact hole 24 and planarization film 23 are covered with pixel electrode 25 made from an indium-tin-oxide (ITO) film. Pixel electrode 25 is electrically connected to drain electrode 22 through contact hole 24 and is controlled to turn on or off by TFT device 5 connected to drain electrode 22.

Planarization film 23 and pixel electrode 25 are covered with alignment film 26 made of a polyimide (PI) resin film. Alignment film 26 is rectangular in a plan view to cover each pixel 6 formed on glass plate 3.

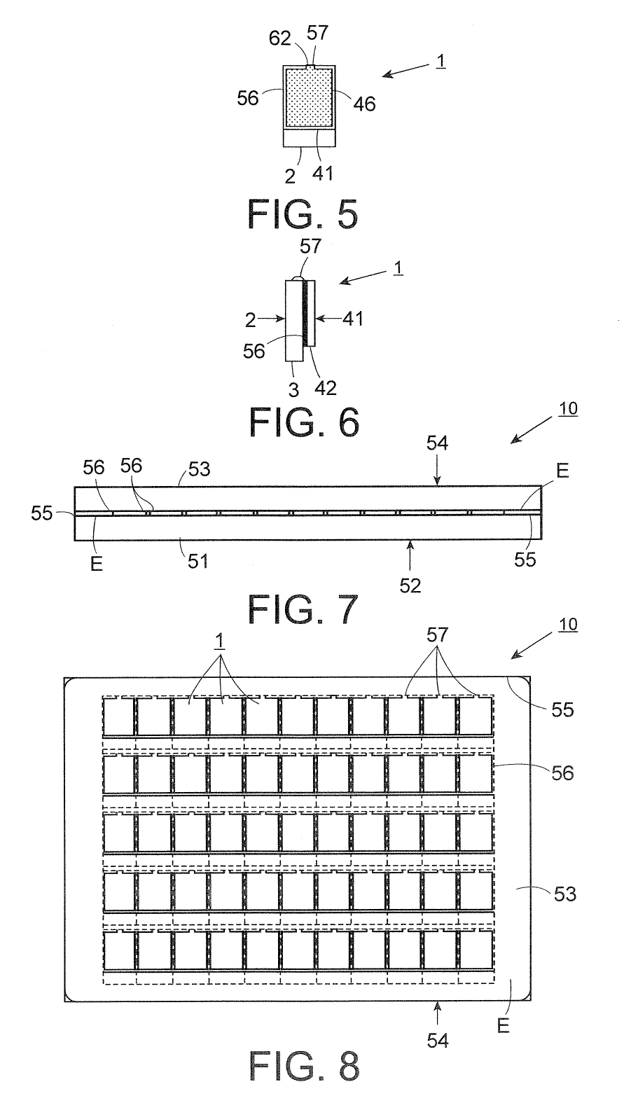

Rectangular counter substrate 41, on the other hand, is provided opposite to pixel array substrate 2 as a second substrate. As shown in FIGS. 5 and 6, counter substrate 41 is provided with an extending portion from a side when pixel array substrate 2 and counter substrate 41 are put together. Counter substrate 41 is made at a thermal history different from that at which pixel array substrate 2 is made. A not more than 220° C. process, for example, is applied to make counter substrate 41 but a higher temperature process than that is applied to make pixel array substrate 2. In other words, counter substrate 41 is made at a lower temperature than pixel array substrate 2. Further, counter substrate 41 is provided with optically transparent glass plate 42 as an electrically insulating, rectangular substrate.

Glass plate 42 is 0.1 mm in thickness, for example, that is thinner than glass plate 3 of pixel array substrate 2. Color filter layer 43 is provided on a surface of glass plate 42 facing pixel array substrate 2. Color filter layer 43 is a colored layer in which a set of at least two colors, e.g. red, green and blue dots are repeatedly disposed.

Each color filter layer 43 is provided opposite to its corresponding pixel 6 when counter substrate 41 and pixel array substrate 2 are put together. Further, color filter layer 43 is covered with rectangular counter electrode 44 as a common electrode. Counter electrode 44 is rectangular in shape and large enough in size to cover entire regions of pixels 6 on glass plate 3 of pixel array substrate 2 when counter substrate 41 is set opposite to pixel array substrate 2.

In other words, when counter substrate 41 is set opposite to pixel array substrate 2, pixels 6 of pixel array substrate 2 are provided to face counter electrode 44. Further, counter electrode 44 is covered with alignment film 45 as in the case of alignment film 26 of pixel array substrate 2.

Counter substrate 41 and pixel array substrate 2 are put together for alignment film 45 to face alignment film 26. Pixel electrodes 25 of pixel array substrate 2 are disposed opposite to counter electrode 44 of counter substrate 41. A gap defined between alignment film 45 of counter substrate 41 and alignment film 26 of pixel array substrate 2 is filled with liquid crystal material 46 and its circumference is sealed so that an optical modulation layer is formed. Pixel electrodes 25 of pixel array substrate 2, counter electrode 44 of counter substrate 41, and liquid crystal material 46 form electric capacitors.

A method of manufacturing an LCD device of the first embodiment will be described below with reference to the attached drawings.

Large glass plate 51 is 0.6 mm thick and large enough in size to provide for a plurality of pixel array substrates 2. A plasma chemical vapor deposition (CVD) method or the like is applied to form undercoat layer 4 on large glass plate 51 at a temperature of 300° C.

Large glass plate 51 has auxiliary regions “E” required for provisional sealing member 55 to protect inlets 57 through which a liquid crystal material is injected.

Next, a plasma enhanced CVD method or a sputtering method is applied to form an amorphous silicon semiconductor film on undercoat layer 4 at a temperature of 300° C.

A laser annealing process is carried out by irradiating excima laser beams onto the amorphous semiconductor film so that the amorphous semiconductor film is melted and crystallized into a ploy-crystalline silicon semiconductor film.

The ploy-crystalline silicon semiconductor film is subjected to an island-like patterning to form active semiconductor layers 11.

Subsequently, a plasma enhanced CVD method or electron-cyclotron resonance CVD method is applied to form silicon oxide (SiOX) gate insulation film 15 on active semiconductor layers 11 and undercoat layer 4 at a temperature of 300° C.

A sputtering method or the like is used to form a molybdenum-tantalum (Mo—Ta) alloy film or a molybdenum-wolfram (Mo—W) alloy film, which is further subjected to a patterning process to make gate electrodes 16.

An n-type impurity of phosphorus (P) or a p-type impurity of boron (B) is highly ion-doped into active semiconductor layer 11 through gate electrode 16 used as a mask to form n+ layers or p+ layers of source region 13 and drain region 14 of TFT device 5 on both sides of active semiconductor layer 11, respectively.

Active semiconductor layer 11 of TFT device 5 is then annealed at a temperature of about 400° C. to activate the impurities doped in active semiconductor layer 11 of TFT device 5. This time large glass plate 51 is also heated at about 400° C.

A plasma enhanced CVD is then carried out to form silicon oxide interlayer insulation film 17 at a temperature of 300° C. on gate electrodes 16 of TFT device 5 and gate insulation film 15.

Interlayer insulation film 17 and gate insulation film 15 are patterned to make contact holes 18 and 19 and part of source regions 13 and drain regions 14 of TFT devices 5 is exposed.

A sputter method is then carried out to form a metal layer in contact holes 18 and 19 and on interlayer insulation film 17 to which a dry etching and patterning process is applied to make source electrodes 21 and drain electrodes 22 of TFT devices 5.

Next, a plasma enhanced CVD method is carried out to form silicon nitride (SiN) planarization film 23 on source electrodes 21, drain electrodes 22 and interlayer insulation film 17 at a temperature of 300° C. Thus, each TFT device 5 is completed.

Contact holes 24 are made in planarization film 23 while part of drain electrodes 22 of TFT devices 5 is exposed.

A sputtering method is carried out to form an optically transparent and electrically conductive film in contact hole 24 and on planarization film 23, which is further subjected to a patterning process to make pixel electrodes 25.

Alignment film 26 is then formed on pixel electrodes 25 and planarization film 23 so that a plurality of connected pixel array substrates 2 are completed on large glass plate 51.

0.6 mm thick large glass plate 53, as shown in FIG. 2, that is the same in size as large glass plate 51 is then prepared. Large glass plate 53 is coated with a photo-resist film made from an ultraviolet curing acrylic resin by a spin coater to form a photo-resist mask.

Large glass plate 53 as in the case of large glass plate 51 has auxiliary regions E required for provisional sealing member 55 to protect inlets 57 through which a liquid crystal material is injected.

Next, 365 nm wavelength and 100 mJ/cm² intensity laser beams, for example, are irradiated through photo-masks placed on large glass plate 53. After photolithography and patterning processes are carried out, large glass plate 53 is developed in 1% solution of potassium hydrate (KOH) in water for 20 seconds to form color filter layer 43. Large glass plate 53 is then baked at a temperature of 220° C. or lower.

Subsequently, a sputtering method is used to form a 500-10 nm thick ITO film on color filter layer 43, which is, in turn, patterned to make counter electrode 44.

Counter electrode 44 of large glass plate 42 is coated with a 800-10 nm thick alignment film 45, which is rubbed with clothe and is baked at a temperature of 200° C. or so. Large counter substrate 54 is made of a plurality of connected counter substrates 41.

Alignment films 26 of large pixel array substrate 52 are set opposite to alignment films 45 of large counter substrate 54. Large pixel array substrate 52 and large counter substrate 54 are put together, and are heated for provisional sealing member 55 to seal their circumferences and for sealing member 56 to seal pixel array substrates 2 and counter substrates 41 at the same time.

Inlets 57, however, are not sealed by sealing member 56 of large glass plates 51 and 53.

Sealing member 56 is provided depending on the design of LCD panels included in large glass plates 51 and 53 while each LCD panel 1 is provided with inlet 57 to inject a liquid crystal material. Provisional sealing member 55 is disposed around a circumference of large glass plates 51 and 53. Provisional sealing member 55 prevents chemical or mechanical polishing solution from soaking in LCD panel 1. Thus, sealing member 55 is closed loop-like in shape and provided around the circumference of large glass plates 51 and 53.

A gap defined between large glass plates 51 and 53 by provisional sealing member 55 has an influence over the flow of chemical polishing solution and may easily cause uneven polishing surfaces. Thus, provisional sealing member 55 is provided at such edge portions of large glass plates 51 and 53 with such a width that large glass plates 51 and 53 are overlapped with each other. Provisional sealing member 55 is preferably 1 mm in width or more from a view point of mechanical strength.

Provisional sealing member 55 and sealing member 56 are hardened by the irradiation of heat and light to put large glass plates 51 and 53 together, which are soaked in chemical polishing solution of strong acid such as hydrofluoric acidic solution to chemical make the outer surfaces of large glass plates 51 and 53 into water glass and thin at the same time. In other words, a chemical polishing or etching method polishes each outer surface of large glass plates 51 and 53 and simultaneously makes the same thin.

Since each outer surface of large glass plates 51 and 53 is protected by the water glass at this stage, large glass plates 51 and 53 are oscillated to remove the water glass from the outer surfaces of large glass plates 51 and 53. The outer surfaces of large glass plates 51 and 53 exposed are soaked in the chemical polishing solution which is uniformly circulated by convection.

When large glass plates 51 and 53 become a predetermined thickness, large glass plates 51 and 53 are taken away from the chemical polishing solution. Water glass and residue solution are removed from large glass plates 51 and 53 by the flow of water. Thus, the chemical treatment or polishing of large glass plates 51 and 53 is completed.

The measurement of large glass plates 51 and 53 has shown that large glass plate 51 of large pixel array substrate 52 is 0.2 mm in thickness while large glass plate 53 of large counter substrate 54 is 0.1 mm in thickness.

With this situation, small units are separated from large LCD panel 10 as shown in FIG. 4. Large LCD panel 10 is composed of a plurality of lines of strip-like LCD panels 61, each of which includes a plurality of LCD panels 1. Each line of strip-like LCD panels 61 is laterally cut away from large LCD panel 10 to expose inlets 57 of LCD panels 1. Strip-like LCD panels 61 have a plurality of LCD panels 1, such as 11 units of LCD panels 1, in the lateral direction.

Subsequently, liquid crystal material 46 not shown in the drawings is injected into each inlet 57 of strip-like LCD panels 61 in a vacuum and is filled in strip-like LCD panels 61 so that a layer of liquid crystal material 46 is formed between large glass plates 51 and 53 of such cut-away LCD panel 1.

In this condition, sealing material 62 of a light hardened type epoxy resin is coated at inlets 57 of strip-like LCD panels 61, ultra-violet light beams are irradiated to harden sealing material 62, inlets 57 of strip-like LCD panels 61 are sealed, and the liquid crystal material is confined in strip-like LCD panels 61.

Strip-like LCD panels 61 are then cut along the longitudinal direction in a scribing process and are subdivided into a plurality of LCD panels 1. Each LCD panel 1 is made as a single display panel as shown in FIGS. 5 and 6.

Subsequently, such LCD panel 1, and wirings and polarizers not shown are incorporated into an LCD device.

As set forth above, according to the first embodiment of the present invention, since large glass plate 51 of large pixel array substrate 52 is subjected to a high temperature thermal process, such as annealing treatment at about 400° C., a polishing speed of large glass plate 51 is slower to make large glass plate 51 thinner than a large glass plate that is not subjected to the thermal process. Thus, large pixel array substrate 52 is assembled with large counter substrate 54 that is not subjected to comparatively high temperature thermal processes or annealing processes but that is made in a thermal process at a low temperature of not higher than 220° C.

Large pixel array substrate 52 and large counter substrate 54 thus assembled are then immersed simultaneously in chemical polishing solution and taken out from the chemical polishing solution simultaneously after a predetermined time of such immersion. Surfaces of large glass plate 51 of large pixel array substrate 52 and those of large glass plate 53 of large counter substrate 54 are simultaneously chemical polished.

As a result, large glass plate 51 of large pixel array substrate 52 that is highly subjected to a thermal history is thicker in thickness than large glass plate 53 of large counter substrate 54 that is subjected to a lower thermal history. In other words, if large glass plates 51 and 53 with different thermal histories during their production processes are only subjected to chemical treatment to make them thin on fixed conditions, respectively, large glass plate 51 of large pixel array substrate 52 can be designed to be thicker in thickness than large glass plate 53 of large counter substrate 54.

Thus, no substantially carrying limitations or significant problems are caused for a carrier in the same production line to carry different thicknesses of large glass plates 51 and 53 in comparison with the production of an LCD device in which different thicknesses of glass plates are prepared prior to a polishing process. No critical warps or curves due to a difference between thermal-expansion coefficients of large glass plates 51 and 53 are formed when large glass plates 51 and 53 are assembled with each other by provisional sealing member 55 and by sealing member 56. Since low production yield factors of an LCD device are reduced, the production yield rate can be easily improved in LCD panel 1 manufactured by dividing large glass plates 51 and 53.

Polishing treatment or handling of large glass plates 51 and 53 is easier and avoids the occurrence of poor components as much as possible, such as breaking or chipping of large glass plates 51 and 53, in comparison with conventional mechanical polishing treatment of a surface of a large glass plate of a large counter substrate to make that large glass plate thinner than a large glass plate of a large pixel array substrate. More particularly, the breakage or chipping of a large glass plate can be prevented in a polishing process as well as in a scribing process. LCD panel 1 in which glass plate 42 is thinner in thickness than glass plate 3 of pixel array substrate 2 is manufactured well in production yield without the usage of any complicated control process. Thus, thin LCD panel 1 can be made at a high production yield rate.

In addition, since large pixel array substrate 52 and large counter substrate 54 are assembled and are then immersed in chemical polishing solution, a polishing quantity per unit time of large pixel array substrate 52 and large counter substrate 54 is greater than that of mechanical polishing treatment for large pixel array substrate 52 and large counter substrate 54, and such chemical polishing treatment can be effectively carried out for large pixel array substrate 52 and large counter substrate 54. A polishing speed may be changed by selecting materials or quality of large glass plates 51 and 53 of large pixel array substrate 52 and large counter substrate 54, respectively. Further, since large glass plate 51 of large pixel array substrate 52 is allowed to be different in thickness from large glass plate 53 of large counter substrate 54, no additional production process is required while the production process is simplified. Thus, no development of a new process or equipment is necessitated and the production yield is still little affected.

### Second Embodiment

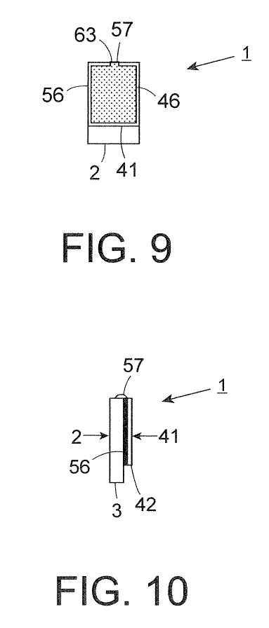

A second embodiment of the present invention will be described below with reference to FIGS. 7-10. In the second embodiment, large pixel array substrate 52 is formed on 0.7 mm thick large glass plate 51 processed at temperatures ranging from not lower than 400° C. to not higher than 500° C. Large counter substrate 54 is also formed on 0.7 mm thick large glass plate 53 also processed at temperatures of not higher than 220° C. Large pixel array substrate 52 and large counter substrate 54 are assembled with each other, are made thin simultaneously and are divided into LCD panels 1 into which liquid crystal materials are injected respectively.

More concretely, large pixel array substrate 52 is not subjected to annealing treatment before TFT devices 5, source electrodes 21 or drain electrodes 22 are formed on large glass plate 51. Low temperature poly-crystalline-silicon (p-Si) transistors as TFT devices are formed on large glass plate 51 of large pixel array substrate 52. Thus, large pixel array substrate 52 is provided with large glass plate 51 subjected to a poly-crystalline-silicon transistor forming process at temperatures ranging from not lower than 400° C. to not higher than 500° C.

Large counter substrate 54 is also not subjected to annealing treatment yet and processes for forming color filter layers 43 and counter electrode 44 are carried out at a maximum temperature of not higher than 220° C.

As shown in FIGS. 7 and 8, large pixel array substrate 52 and large counter substrate 54 are assembled with provisional sealing member 55 and sealing member 56 and are immersed in chemical polishing solution to make large glass plates 51 and 53 thin. Large glass plate 51 of large pixel array substrate 52 becomes 0.15 mm in thickness while large glass plate 53 of large counter substrate 54 becomes 0.05 mm in thickness.

Further, large glass plates 51 of large pixel array substrate 52 and large glass plates 53 of large counter substrate 54 are made thin, are cut away along lateral and longitudinal directions of large glass plates 51 and 53, and are divided into a plurality of LCD panels 1 as shown in FIGS. 8-10. Each LCD panel 1 is filled with a liquid crystal material through inlet 57. After inlet 57 is sealed with sealing material 62, wirings, a polarizer and the like are assembled with LCD panel 1 to form a complete LCD device.

As described above, according to the second embodiment, even if large pixel array substrate 52 formed at a maximum temperature ranging from not lower than 400° C. to not higher than 500° C. on 0.7 mm thick, large glass plate 51 and large counter substrate 54 formed at a maximum temperature of not higher than 220° C. on 0.7 mm thick large glass plate 53 are assembled with each other, are immersed in the chemical polishing solution and are made thin simultaneously, large glass plate 51 of large pixel array substrate 52 can be made different in thickness from large glass plate 53 of large counter substrate 54 and glass plates 51 and 53 can be prevented from breaking or chipping in the same function and effect as of the first embodiment.

In the first embodiment, large pixel array substrate 52 formed at the maximum temperature ranging from not lower than 400° C. to not higher than 500° C. on 0.7 mm thick, large glass plate 51 is assembled with large counter substrate 54 formed at the maximum temperature of not higher than 220° C. on 0.6 mm thick large glass plate 53, and large pixel array substrate 52 and large counter substrate 54 are made thin simultaneously. In the second embodiment, large pixel array substrate 52 formed at the temperature of 400° C. on 0.6 mm thick, large glass plate 51 is assembled with large counter substrate 54 formed at the maximum temperature of not higher than 220° C. on 0.6 mm thick large glass plate 53, and large pixel array substrate 52 and large counter substrate 54 are made thin simultaneously. Alternative modifications to the embodiments may be carried out. That is, if a thermal history of large pixel array substrate 52 is different by not lower than 200° C. from that of large counter substrate 54, and large pixel array substrate 52 and large counter substrate 54 are assembled with each other and immersed in chemical polishing solution and are made thin simultaneously, large glass plate 51 of large pixel array substrate 52 can be made different in thickness from large glass plate 53 of large counter substrate 54.

Here, in order to make large pixel array substrate 52 different in thickness from large counter substrate 54, generally, a thermal history of large pixel array substrate 52 is required to be different by not lower than 200° C. from that of large counter substrate 54 although glass materials or other conditions must be taken into consideration. The present invention, however, is not limited to those embodiments and modifications.

More concretely, if large pixel array substrate 52 is preferably formed at a temperature ranging from not lower than 500° C. to not higher than 600° C. and large counter substrate 54 is formed at a temperature of not higher than 240° C. as far as a thermal history is concerned, large pixel array substrate 52 is assembled with large counter substrate 54 and large pixel array substrate 52 and large counter substrate 54 are simultaneously immersed in chemical polishing solution, large pixel array substrate 52 can be made more accurately different in thickness from large counter substrate 54.

### Third Embodiment

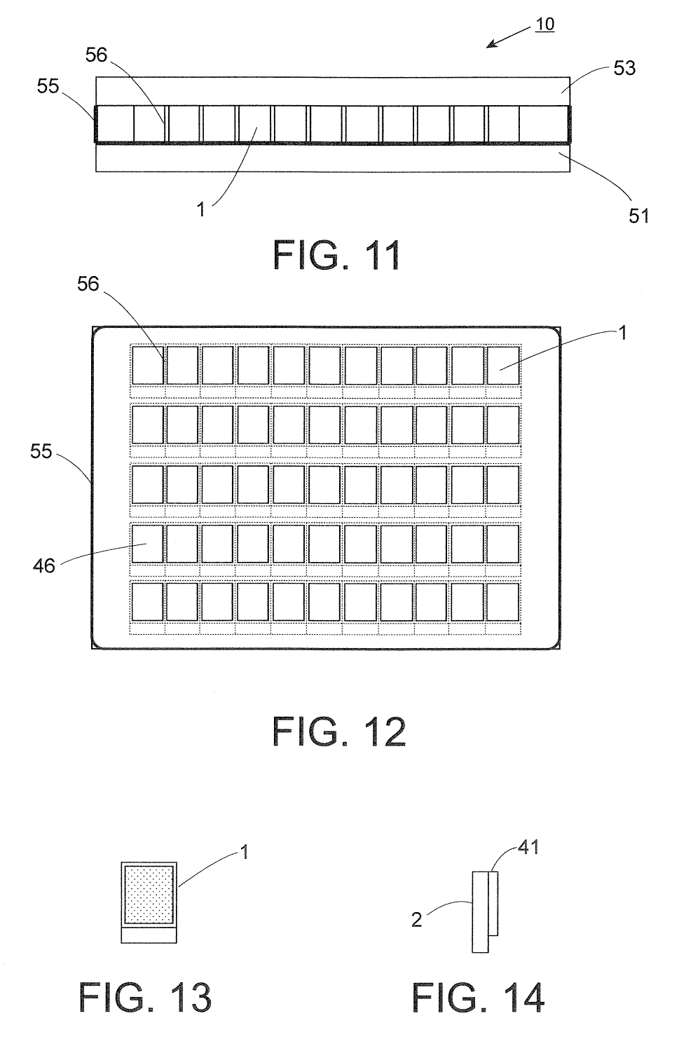

A third embodiment of the present invention will be described below with reference to FIGS. 11-14. A method of manufacturing an LCD device is schematically shown in FIG. 11. 0.6 mm thick large glass plates 51 and 53 are prepared to be assembled into large LCD panel 10. Large glass plate 51 is annealed at a temperature of 400° C. in advance. TFT devices and electrodes to drive a liquid crystal layer are formed on large glass plate 51 to produce a pixel array substrate is produced. Large glass plate 53 is not subjected to such annealing treatment but color filters, a counter electrode, etc. are formed on large glass plate 53 at a temperature of not higher than 240° C. to produce a counter substrate. As shown in FIGS. 11 and 12, a plurality of LCD panels 1 are disposed in large LCD panel 10. Each pixel array substrates and counter substrates of LCD panel 1 is glued together with sealing member 56 while a circumference of large LCD panel 10 is sealed with provisional sealing member 55. Spaces of regions separated by sealing member 56 are filled with designed drops of liquid crystal material 46. Thus, large glass plates 51 and 53 glued with thermally or optically hardened sealing members 55 and 56 are immersed in chemical polishing solution, such as hydrofluoric acidic solution, to chemically change surfaces of large glass plates 51 and 53 to water glass. Since the surfaces of large glass plates 51 and 53 are protected by water glass, large glass plates 51 and 53 are swung to remove the water glass from the surfaces, so that new surfaces of large glass plates 51 and 53 are exposed. Further, the hydrofluoric acidic solution is uniformly circulated by convection to react on both surfaces of large glass plates 51 and 53. As a result, when thicknesses of large glass plates 51 and 53 become predetermined values, large glass plates 51 and 53 are taken out from the hydrofluoric acidic solution and remaining hydrofluoric acidic solution and water glass are removed from the surfaces of large glass plates 51 and 53 by running water over them. Thus, when the polishing process is completed, pixel array substrate 2 and counter substrate 41 measure 0.2 mm and 0.1 mm in thickness. A plurality of LCD panels 1 are then cut away from large LCD panel 10 by a conventional process. Wirings and polarizers are assembled with each LCD panel 1 into an LCD module in a conventional way. FIGS. 13 and 14 show plan and side views of single LCD panel 1, respectively. No cracks or breakages of pixel array substrate 2 and counter substrate 41 of LCD panel 1 result from the polishing and/or scribing process in this manufacturing method.

Although large pixel array substrate 52 and large counter substrate 54 are assembled with each other and are then immersed in chemical polishing solution to make them thin simultaneously, even other chemical treatment than the immersion of large pixel array substrate 52 and large counter substrate 54 in the chemical polishing solution can be used if the same can make large pixel array substrate 52 and large counter substrate 54 differently thin in thickness from each other.

The thermal history of large pixel array substrate 52 is not limited to a temperature equal to or higher than 600° C. but may include a temperature of not higher than a glass melting point temperature.

Further, the present invention can be also applied to other type transistors than co-planar type thin-film transistors, such as top-gate thin-film transistors and bottom gate type thin-film transistors.

In the foregoing description, certain terms have been used for brevity, clearness and understanding, but no unnecessary limitations are to be implied therefrom beyond the requirements of the prior art, because such words are used for descriptive purposes herein and are intended to be broadly construed. Moreover, the embodiments of the improved construction illustrated and described herein are by way of example, and the scope of the invention is not limited to the exact details of construction. Having now described the invention, the construction, the operation and use of embodiments thereof, and the advantageous new and useful results obtained thereby, the new and useful construction, and reasonable equivalents thereof obvious to those skilled in the art, are set forth in the appended claims.

What is claimed is:

1. A method of manufacturing a liquid crystal display device comprising:
preparing a first substrate subjected to first heating treatment at a first temperature;
preparing a second substrate subjected to second heating treatment at a second temperature that is different from the first temperature;
making the first substrate opposite to the second substrate and assembling the first substrate with the second substrate;
carrying out chemical treatment of the first substrate and the second substrate assembled with the first substrate to make the first and second substrates thin in thickness simultaneously;
injecting a liquid crystal material into a gap defined between the first and second substrates subjected to the chemical treatment; and
sealing the first and second substrates.

2. A method of manufacturing a liquid crystal display device according to claim 1, wherein the first temperature is higher than the second temperature.

3. A method of manufacturing a liquid crystal display device according to claim 1, wherein the first substrate is a pixel array substrate including a first isolation plate on which a plurality of pixels are formed,
the first temperature ranges from not lower than 500° C. to not higher than 600° C.,
the second substrate is a counter substrate including a second isolation plate on which color filter layers and a counter electrode are formed, and
the second temperature is not higher than 240° C.

4. A method of manufacturing a liquid crystal display device according to claim 2, wherein the first substrate is a pixel array substrate including a first isolation plate on which a plurality of pixels are formed,
the first temperature ranges from not lower than 500° C. to not higher than 600° C.,
the second substrate is a counter substrate including a second isolation plate on which color filter layers and a counter electrode are formed, and
the second temperature is not higher than 240° C.

5. A method of manufacturing a liquid crystal display device according to claim 1, wherein the first substrate includes connected pixel array substrates, the second substrate includes connected counter substrates provided corresponding to the plurality of pixel array substrates, further comprising:
dividing the first and second substrates into a plurality of the pixel array substrates and a plurality of the counter substrates after making the first and second substrates thin in thickness through the chemical treatment simultaneously.

6. A method of manufacturing a liquid crystal display device according to claim 2, wherein the first substrate includes connected pixel array substrates, the second substrate includes connected counter substrates provided corresponding to the plurality of pixel array substrates, further comprising:
dividing the first and second substrates into a plurality of the pixel array substrates and a plurality of the counter substrates after making the first and second substrates thin in thickness through the chemical treatment simultaneously.

7. A method of manufacturing a liquid crystal display device according to claim 3, wherein the first substrate includes connected pixel array substrates, the second substrate includes connected counter substrates provided corresponding to the plurality of pixel array substrates, further comprising:
dividing the first and second substrates into a plurality of the pixel array substrates and a plurality of the counter substrates after making the first and second substrates thin in thickness through the chemical treatment simultaneously.

8. A method of manufacturing a liquid crystal display device according to claim 4, wherein the first substrate includes connected pixel array substrates, the second substrate includes connected counter substrates provided corresponding to the plurality of pixel array substrates, further comprising:
dividing the first and second substrates into a plurality of the pixel array substrates and a plurality of the counter substrates after making the first and second substrates thin in thickness through the chemical treatment simultaneously.

9. A method of manufacturing a display device according to claim 1, wherein the first substrate includes connected pixel array substrates in longitudinal and lateral directions, the second substrate includes connected counter substrates provided corresponding to the plurality of pixel array substrates in the longitudinal and lateral directions, further comprising:
firstly dividing the first and second substrates into a plurality of the pixel array substrates provided corresponding to the counter substrates in one of the longitudinal and lateral direction after making the first and second substrates thin in thickness through the chemical treatment simultaneously after the injecting of the liquid crystal material into the gap, and
secondly dividing the plurality of the firstly divided pixel array substrates provided corresponding to the counter substrates in another of the longitudinal and lateral directions.

10. A method of manufacturing a display device according to claim 2, wherein the first substrate includes connected pixel array substrates in longitudinal and lateral directions, the second substrate includes connected counter substrates provided corresponding to the plurality of pixel array substrates in the longitudinal and lateral directions, further comprising:
firstly dividing the first and second substrates into a plurality of the pixel array substrates provided corresponding to the counter substrates in one of the longitudinal and lateral direction after making the first and second substrates thin in thickness through the chemical treatment simultaneously after the injecting of the liquid crystal material into the gap, and
secondly dividing the plurality of the firstly divided pixel array substrates provided corresponding to the counter substrates in another of the longitudinal and lateral directions.

11. A method of manufacturing a display device according to claim 3, wherein the first substrate includes connected pixel array substrates in longitudinal and lateral directions, the second substrate includes connected counter substrates provided corresponding to the plurality of pixel array substrates in the longitudinal and lateral directions, further comprising:
firstly dividing the first and second substrates into a plurality of the pixel array substrates provided corresponding to the counter substrates in one of the longitudinal and lateral direction after making the first and second substrates thin in thickness through the chemical treatment simultaneously after the injecting of the liquid crystal material into the gap, and
secondly dividing the plurality of the firstly divided pixel array substrates provided corresponding to the counter substrates in another of the longitudinal and lateral directions.

12. A method of manufacturing a display device according to claim 4, wherein the first substrate includes connected pixel array substrates in longitudinal and lateral directions, the second substrate includes connected counter substrates provided corresponding to the plurality of pixel array substrates in the longitudinal and lateral directions, further comprising:
firstly dividing the first and second substrates into a plurality of the pixel array substrates provided corresponding to the counter substrates in one of the longitudinal and lateral direction after making the first and second substrates thin in thickness through the chemical treatment simultaneously after the injecting of the liquid crystal material into the gap, and
secondly dividing the plurality of the firstly divided pixel array substrates provided corresponding to the counter substrates in another of the longitudinal and lateral directions.

13. A liquid crystal display device comprising:
a first substrate subjected to first heating treatment at a first temperature;
a second substrate subjected to second heating treatment at a second temperature that is different from the first temperature, the second substrate being provided opposite to the first substrate; and
a liquid crystal material injected into a gap defined between the first substrate and the second substrate assembled with the first substrate;
wherein the first substrate and the second substrate assembled with the first substrate are subjected to chemical treatment to make the first and second substrates thin in thickness simultaneously.

14. A method of manufacturing a liquid crystal display device comprising:
preparing a first substrate subjected to first heating treatment at a first temperature;
preparing a second substrate subjected to second heating treatment at a second temperature that is different from the first temperature, said second substrate having a thickness which is substantially equal to a thickness of the second substrate;
making the first substrate opposite to the second substrate and assembling the first substrate with the second substrate with a sealing member;
filling a liquid crystal material into a space defined the first substrate and the second substrate assembled with the first substrate;
carrying out chemical treatment of the first substrate and the second substrate assembled with the first substrate to make the first and second substrates thin in thickness simultaneously; and
separating the first substrate assembled with the second substrate into a plurality of liquid crystal display panels after the chemical treatment of the first substrate and the second substrate.

15. A liquid crystal display device comprising:
a first substrate subjected to first heating treatment at a first temperature;
a liquid crystal material dropped on the first substrate; and
a second substrate subjected to second heating treatment at a second temperature that is different from the first temperature, the second substrate being provided opposite to the first substrate on which the liquid crystal material is dropped,
wherein the first substrate and the second substrate assembled with the first substrate are subjected to chemical treatment to make the first and second substrates thin in thickness simultaneously.
